(19) United States
(12) Patent Application Publication
(10) Pub. No.: US 2025/0332893 A1
(43) Pub. Date: Oct. 30, 2025

(54) VEHICLE DOOR ASSEMBLY WITH SINGLE A POST

(71) Applicant: Michal Simko, Swanscombe (GB)

(72) Inventor: Michal Simko, Swanscombe (GB)

(21) Appl. No.: 19/189,665

(22) Filed: Apr. 25, 2025

(30) Foreign Application Priority Data
Apr. 26, 2024 (GB) 2405935.4

(51) Int. Cl. B60J 5/04; B60J 1/06; B60J 1/17; B62D 1/183; B62D 5/00; B62D 25/04; E05F 15/00

(52) U.S. Cl. CPC B60J 5/0473; B60J 1/06; B60J 1/17; B62D 1/183; B62D 25/04; E05F 15/00; B60J 2005/0475; B62D 5/001; E05Y 2900/531

(57) ABSTRACT

The present invention relates to a vehicle door assembly with a single A post, significantly deviating from conventional multi-post door structures. This innovative closure system, primarily envisioned for sports and high-performance vehicles, is versatile to be adapted across a wide range of vehicle categories. The core innovation lies in the integration of car doors mounted along the vehicle's centerline, with door hinges directly affixed to a centrally located single A post. This arrangement facilitates the division of the windshield into two halves, each corresponding to a door, allowing both the left and right portions of the windshield to open in unison with the movement of their respective doors. The invention introduces several advantages over traditional automotive door designs, including enhanced driver visibility, improved vehicle body stiffness, reduced manufacturing costs and vehicle weight, expanded door opening aperture, and improved ease of entry and exit for passengers.

### CROSS REFERENCE TO RELATED APPLICATION

This application claims priority to GB Patent Application No. 2405935.4, which was filed on 26 Apr. 2024, the disclosure of which is incorporated herein by reference.

### TECHNICAL FIELD OF THE INVENTION

The present invention generally relates to automotive engineering, specifically focusing on design and structural innovation of vehicle doors. More particularly, the present invention introduces a novel approach to the configuration and functionality of automotive doors through implementation of a vehicle door assembly with a single A post structure, which aims to enhance the performance, safety, and user experience of sports cars, high-performance vehicles, and other vehicle types by addressing and improving upon several aspects of traditional door designs, including driver's visibility, vehicle body stiffness, cost-efficiency, and ease of passenger's entry and exit.

### BACKGROUND OF THE INVENTION

The automotive industry has seen a variety of vehicle door configurations designed to meet different functional, safety and aesthetic requirements.

One of traditional vehicle door designs includes a conventional door, also known as a regular door, which is the most common type of car doors. The conventional door is hinged at the front-facing edge of the door, and usually is provided with a handle on the outside and a latch or lock mechanism on the inside.

Another type of a vehicle door, which is called a suicide door (also known as a rear-hinged door) is hinged at the rear-facing edge of the door rather than the front-facing edge. The suicide door was once common but is now rare due to safety concerns, as it can open accidentally while driving.

Commonly used vehicle door configurations include sliding doors that are often found in vans and some larger vehicles. The sliding doors slide open horizontally instead of swinging outwards. They are convenient in tight spaces but may require more maintenance.

Other known vehicle door types are gull-wing doors, butterfly doors and scissor doors. Gull-wing doors are hinged on their uppermost edge and swing upwards, similarly to the wings of a bird. They are often used in sports cars and exotics, offering a unique and stylish entry but may be impractical in tight parking spaces and they are difficult to reach when closing from seated position in the vehicle.

Butterfly doors are similar to gull-wing doors. The butterfly doors open upwards, but they also have a secondary hinge closer to the center of the vehicle, allowing the door to pivot upwards and outwards. This design is often found in high-performance cars.

Scissor doors, also known as “Lambo doors” due to their association with Lamborghini (Registered Trademark), pivot vertically at a fixed hinge near the front of the car, to move forward and upward. They provide a striking aesthetic but can be cumbersome in certain situations.

Each of the above-mentioned vehicle door types has its advantages and limitations in terms of functionality, safety, space requirements and aesthetics. However, they all share a common reliance on multiple posts (A post, B post, and sometimes C post) to support the door structure and maintain vehicle integrity, which can impede visibility, add weight, and complicate the design.

The closest prior art to the present invention is a canopy door that is commonly seen in supercars like the McLaren F1 (Registered Trademark), and comprises a single piece sitting on top of a car, which lifts up and forward exposing the entire interior of the car. The canopy door consists of the vehicle side body, door glass (and in some cases, windshield) and small portion of the vehicle roof. The canopy door features two hinges: the first hinge is situated on the roof of the car, while the second hinge is typically found either at the A post or in the door waist area near the side view mirror. This type of a vehicle door offers easy access but requires ample space above the vehicle to open fully. Also, the canopy door requires two A posts that are located on both left-and right-hand sides of the windshield. Furthermore, in situations of bad weather such as snow, rain, or hail, it is impossible to enter or exit the vehicle without getting the interior wet.

In light of the foregoing, there exists a need to overcome at least some of the aforementioned drawbacks. Particularly, there is a need for an improved vehicle door configuration adaptable to various vehicle types, including sports and high-performance vehicles, which could feature an improved visibility for a driver, an improved body stiffness, an enhanced passenger ingress and egress, an enhanced vehicle body stiffness, an enhanced safety for cyclists and pedestrians moving nearby, while allowing a decreased vehicle body weight, reduced manufacturing costs and a simplified and compact design ensuring comfortable parking in a narrow parking space.

### SUMMARY OF THE INVENTION

In order to effectively solve the above-mentioned tasks existing in the state of the art, an innovative type of an automotive door assembly has been developed according to the present invention, which significantly differs from the conventional multi-post automotive door configurations by featuring a single A-post structure and doors that are mounted along the vehicle's centerline with door hinges affixed to a centrally positioned A post, thereby reducing the structural complexity and addressing the limitations of existing door mechanisms, and thus presenting a significant technical advancement in automotive door design. The present invention is primarily aimed at sports and high-performance vehicles but offers broad applicability across various vehicle types due to its versatile nature. The proposed door assembly enables the division of the windshield into two symmetrical halves, each aligned with a respective door, allowing both the left and right portions of the windshield to open in conjunction with their corresponding doors. As a result, the design necessitates a singular A post located at the center of the windshield, revolutionizing the vehicle's structural and operational dynamics.

According to one aspect of the invention, a vehicle door assembly is provided, comprising a door and an A post positioned substantially along a centerline of a vehicle, wherein the door is movably attached to the A post by at least two hinges at corresponding at least two locations along the A post, wherein the door comprises a portion of a windshield of the vehicle, and wherein the door is a left-hand door or a right-hand door.

According to another aspect of the invention, a vehicle door assembly is provided, comprising a left-hand door, a right-hand door, a windshield, and an A post positioned substantially along a centerline of a vehicle, wherein each of the left-hand door and the right-hand door is movably attached to the A post by at least two hinges at corresponding at least two locations along the A post, and wherein the windshield consists of a left-hand windshield section and a right-hand windshield section, which are separated from each other and comprised by the left-hand door and the right-hand door respectively, allowing the left-hand windshield section to open with the left-hand door and the right-hand windshield section to open with the right-hand door.

According to one more aspect of the invention, a vehicle is provided, comprising the vehicle door assembly according to one of the aspects of the present invention, as mentioned above.

Preferably, one of the at least two hinges of the door is located on the A post in an area of a lower part of the windshield, and another one of the at least two hinges is located on the A post in an area of an upper part of the windshield. Preferably, the at least two hinges of the left-hand door form a singular, left-hand door hinge axis located on the A post, and the at least two hinges of the right-hand door form a singular, right-hand door hinge axis located on the A post.

Preferably, the left-hand door and the right-hand door are symmetrically identical, and the left-hand windshield section and the right-hand windshield section are symmetrically identical.

Preferably, the door is further supported via a supporting mechanism to facilitate smooth opening and closing, the supporting mechanism preferably selected from a gas strut, an electric drive unit, a hydraulic system, a pneumatic system and a spring.

In one of possible embodiments, a door seal is provided along a frame of the door, and/or a body of the vehicle is provided with a door seal corresponding to the secondary door seal.

In another possible embodiment, the door comprises a door striker. Preferably, a body of the vehicle is provided with a corresponding door latch for the door striker.

In a preferable embodiment, a steer-by-wire steering system is provided. In one preferable embodiment, a steer-by-wire steering column of the steer-by-wire steering system is separate from the door and is movable away from a driver seat either by lifting upward and forward or by lifting upward and sideways. Alternatively, the door contains a steer-by-wire steering column mounted on a frame of the door to move together with the door as the door opens for creating more clearance for a driver to enter the vehicle. In one of the embodiments, the steering column comprises a supporting mechanism selected from a gas strut, a spring, an electric drive unit, a hydraulic system, and a pneumatic system. In a preferable embodiment, the steering column and the door are mechanically linked using a gas strut.

Preferably, the door comprises a door frame, the windshield section and a portion of a roof of the vehicle. In another preferable embodiment, the door further comprises a portion of a side body of the vehicle.

Preferably, the windshield section comprised by the door is made as a single glass. Alternatively, the windshield section comprised by the door is composed by two glasses comprising a front glass and a side glass, wherein the side glass is retractable for ventilation.

The present invention offers numerous technical advantages over traditional door designs, including but not limited to the following.
1. Improved driver visibility. By employing a single central A post instead of the conventional dual A-post structures that result in two visibility obstruction areas, the invention significantly enhances the driver's field of view, thereby improving safety and driving experience.
2. Enhanced ease of entry and exit. The single A post automotive door assembly facilitates easier passenger ingress and egress. The expanded door opening aperture surpasses that of the typical car doors, allowing passengers to enter the vehicle upright from the top to the seat, rather than having to bend while entering from the side. Moreover, due to the steer-by-wire system, the steering wheel is no longer mechanically linked to the steering actuator. As a result, when the door opens, the steering wheel moves along with it, making driver ingress and egress even smoother.
3. An enhanced safety for cyclists and pedestrians moving near the vehicle with the single A post door assembly. This is achieved by eliminating the risk of car dooring, where doors open into traffic and can cause accidents. Unlike regular car doors that open sideways and require additional space, the design according to the invention prevents such incidents.
4. Compact design. The innovative single A post automotive door assembly allows for an enhanced clearance between two parked cars in a parking slot. With the door opening upwards, maneuvering in and out of the vehicle poses no difficulty even when parked closely to another car in a narrow parking space or garage.
5. An enhanced vehicle body stiffness. The strategic design and placement of the A post and door mechanisms contribute to increased vehicle body stiffness, resulting in better handling and performance. The adjustment of the opening aperture by relocating it from the side to the upper area of the vehicle enables higher sidewalls, which significantly contributing to the vehicle's torsional stiffness. A taller sidewall structure ensures more efficient torsional load distribution, allowing for reduced material requirements to meet torsional stiffness targets.
6. Reduced cost and weight. The simplified door structure and reduced material requirements lead to a decrease in both the manufacturing cost and the overall weight of the vehicle, contributing to improved fuel efficiency and performance.

As can be seen from the above summary, the present invention represents a significant advancement in automotive door design, addressing the limitations of existing door configurations while providing improved functionality, safety, and user experience.

### BRIEF DESCRIPTION OF THE DRAWINGS

The present invention will be described more fully hereinafter with reference to the accompanying drawings, in which prominent aspects and features of the present invention are illustrated, showcasing its potential variations to suit different vehicle and user needs. Each figure provides insight into the configuration, operation and advantages of the present invention to allow a comprehensive understanding thereof.

FIG. 1 shows a perspective view of a vehicle comprising a vehicle door assembly with a single A post according to an embodiment of the present invention, with the doors fully open.

FIG. 2 shows a front top view of the vehicle shown in FIG. 1.

FIG. 3 shows a rear top view of the vehicle shown in FIG. 1.

FIG. 4 shows a perspective view of one side of the vehicle shown in FIG. 1, with a steering column moved forwards to clear space for passengers to enter the vehicle.

FIG. 5 shows a perspective view of one side of a vehicle comprising a vehicle door assembly with a single A post according to another embodiment of the present invention, with the doors fully open.

FIG. 6 shows a perspective view of a mechanical linkage of a steering column and a left-hand (LH) door of a vehicle door assembly with a single A post according to an embodiment of the present invention.

FIG. 7 shows the perspective view of the mechanical linkage shown in FIG. 6, with the LH door 45 degrees open.

FIG. 8 shows the perspective view of the mechanical linkage shown in FIG. 6, with the LH door fully open.

FIG. 9 shows an opposite perspective view of the mechanical linkage shown in FIG. 8.

FIG. 10 shows a front view of a left-hand (LH) door of a vehicle door assembly with a single A post according to an embodiment of the present invention.

FIG. 11 shows a rear view of the LH door shown in FIG. 10.

FIG. 12 shows a front view of a LH door of a vehicle door assembly with a single A post according to another embodiment of the present invention.

FIG. 13 shows a front view of a LH door of a vehicle door assembly with a single A post according to one more embodiment of the present invention.

The present figures relate to schematic drawings so that any dimension of the elements shown in the drawings may deviate from a specifically implemented setup.

### DETAILED DESCRIPTION OF THE INVENTION

The present invention is now described in more details with reference to non-limiting examples. For example, modifications of specific elements of the preferred embodiments described hereafter may be combined with other modifications so as to provide further embodiments of the present invention.

The terminology used herein is for the purpose of describing particular embodiments only and is not intended to be limiting of the invention. As used herein, the term “and/or” includes any and all combinations of one or more of the associated listed items. As used herein, the singular forms “a”, “an”, and “the” are intended to include respective singular and plural forms, unless the context clearly indicates otherwise. It will be further understood that the terms “comprise(s)” and “contain(s)”, when used in this specification, specify the presence of stated features, elements and/or components, but do not preclude the presence or addition of one or more other features, elements, and/or components. The term “substantially” as used herein means a possible deviation margin of ±5%.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The present invention introduces a groundbreaking automotive door assembly configuration characterized by a single A post structure, aiming to revolutionize the ease of entry and exit, driver's visibility, and overall vehicle architecture. It is particularly intended for motor vehicles, preferably sports and high-performance cars. However, the vehicle door assembly proposed by the present invention is versatile enough to be adapted across a wide range of other vehicle categories and types.

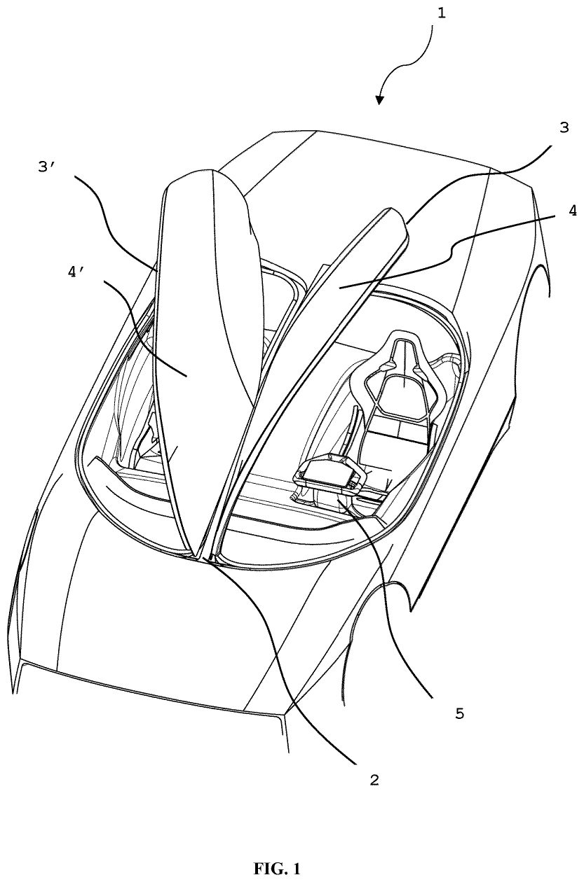

The present invention will now be described by referencing the appended figures representing preferred embodiments. FIG. 1 shows a perspective view of a vehicle 1 comprising a vehicle door assembly according to an embodiment of the present invention. The vehicle door assembly comprises a single A post 2 positioned substantially along a vehicle's centerline, a left-hand (LH) door 3 and a right-hand (RH) door 3′. The vehicle's centerline is the symmetrical center of the vehicle, which extends from a front part of the vehicle to a rear part of the vehicle.

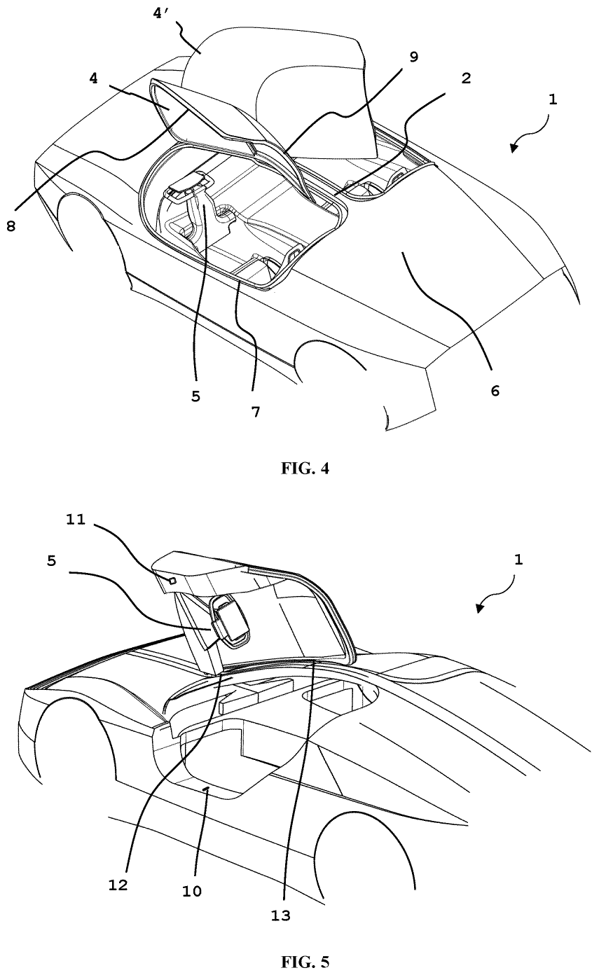

Like traditional car doors, the LH and RH doors 3, 3′ each have two hinges, a lower door hinge 12 and an upper door hinge 13, which are shown in FIG. 5. The lower door hinge 12 of each door 3, 3′ is located at the lower part of the windshield, and the upper door hinge 13 is located at the upper part of the windshield, as shown in FIG. 5. The hinges 12, 13 of the LH door 3 form a singular, left-hand (LH) door hinge axis 16 located on the A post 2, and the hinges 12, 13 of the RH door 3′ form a singular, right-hand (RH) door hinge axis 17 located on the A post 2, as shown in FIG. 3. In this way, the LH and RH doors 3, 3′ are centrally mounted, substantially along the vehicle's centerline, with each door 3, 3′ affixed to the A post 2 by the two door hinges 12, 13 positioned at the different locations along the corresponding LH and RH door hinge axes 16, 17, enabling rotational movement of the doors 3, 3′ upwards along the corresponding LH and RH door hinge axes 16, 17.

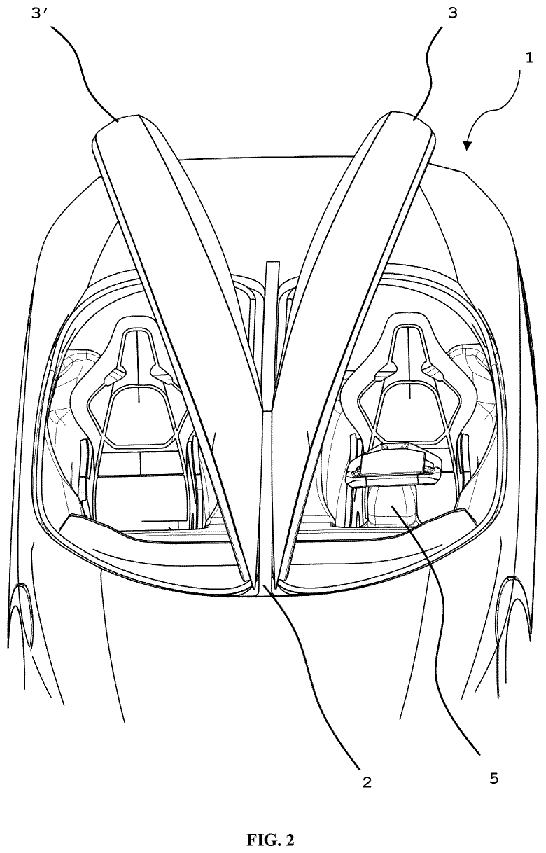

As can be seen in FIG. 2 showing a front top view of the vehicle 1, the vehicle door assembly with a single A post 2 divides a windshield into two symmetrical halves, a left hand (LH) windshield section 4 and a right hand (RH) windshield section 4′, each aligned with respective doors 3 and 3′. Particularly, the LH door 3 contains the LH windshield section 4 and the RH door 3′ contains the RH windshield section 4′, which allows both the LH windshield section 4 and the RH windshield section 4′ to open upwards in conjunction with the respective doors 3 and 3′ (FIG. 1 illustrates a fully open position of the doors 3 and 3′ of the vehicle door assembly). As a result, the configuration according to the invention necessitates a singular A post 2 located at the center of the windshield, revolutionizing the vehicle's structural and operational dynamics.

As the door 3, 3′ of the single A-post vehicle door assembly opens and closes, it is supported via a supporting mechanism (not shown) that assists with the door operation to facilitate smooth opening and closing. The supporting mechanism can be manually operated or automatic. The supporting mechanism can comprise a gas strut (provides a controlled movement), an electric drive unit (enables powered operation), a hydraulic or pneumatic system (provides a controlled movement), a spring (assists in returning the door to its closed position) or any other known aided opening/closing mechanism.

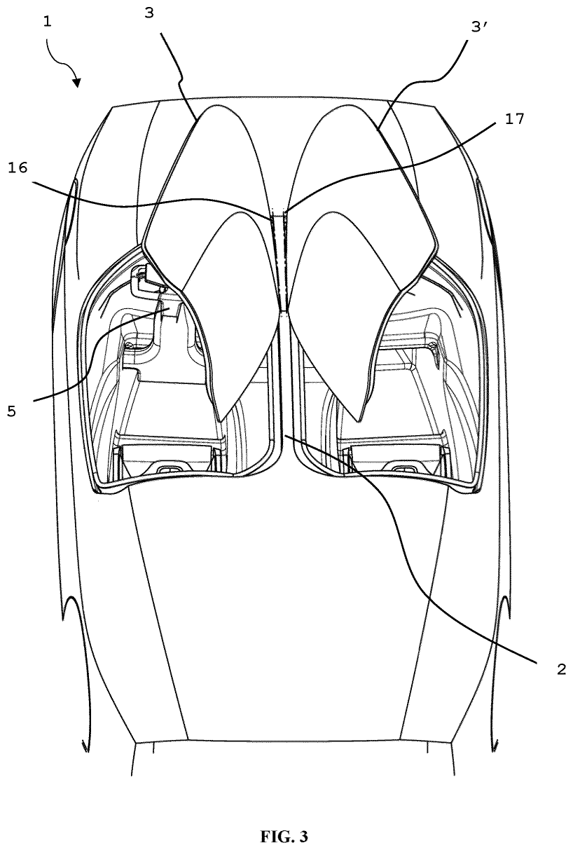

The door 3, 3′ can comprise a secondary door seal 8 provided along the door frame 9, and/or a vehicle body 6 can be provided with a corresponding primary door seal 7, as shown in FIG. 4

The door 3, 3′ can also comprise a door striker 11, and the vehicle body 6 can be provided with a corresponding door latch 10, as shown in FIG. 5. However, any other known door locking can be used alternatively.

The present invention comprises a steer-by-wire steering system. “Steer-by-wire” is an automotive technology that eliminates the mechanical connection between a steering wheel and vehicle wheels themselves. Unlike traditional steering systems, which rely on physical linkages (such as steering columns and shafts), steer-by-wire steering system replaces these components with electronic signals. There's no direct mechanical connection between the steering wheel and the wheels of the vehicle 1.

In the configuration shown in FIG. 4, a steer-by-wire steering column 5 is separate from the door and moves away from the driver either by lifting upward and forward or by lifting upward and sideways. The steering column 5 further comprises a supporting mechanism such as a gas strut, a spring, an electric drive unit, a hydraulic or pneumatic system, or other aided opening/closing devices.

In another, alternative embodiment, which is shown in FIG. 5, the LH door 3 contains the steering column 5 that is mounted on the door frame 9 and moves together with the door as it opens, thereby creating more clearance for a driver to enter the vehicle 1. The steering column 5 is connected to the vehicle 1 via wiring harness located behind the lower door hinge 12. Alternatively, the RH door 3′ can contain the steering column 5 instead of the LH door 3, in case the vehicle 1, for example, is manufactured to be used with the left-hand traffic.

FIG. 6 shows a mechanical linkage of the steering column 5 and the LH door 3 of a vehicle door assembly with a single A post according to a possible embodiment of the present invention. This mechanical linkage can be equally implemented for the steering column 5 and the RH door 3′ in an embodiment wherein the steering column 5 is located from the side of the RH door 3′ in the vehicle 1 manufactured to be used with the left-hand traffic. In the embodiment shown in FIG. 6, the “steering wheel-door” mechanical linkage is implemented with a gas strut 18. The gas strut 18 can be located at any of the links. This setup can be implemented for both a mechanical steering column and a steer-by-wire system.

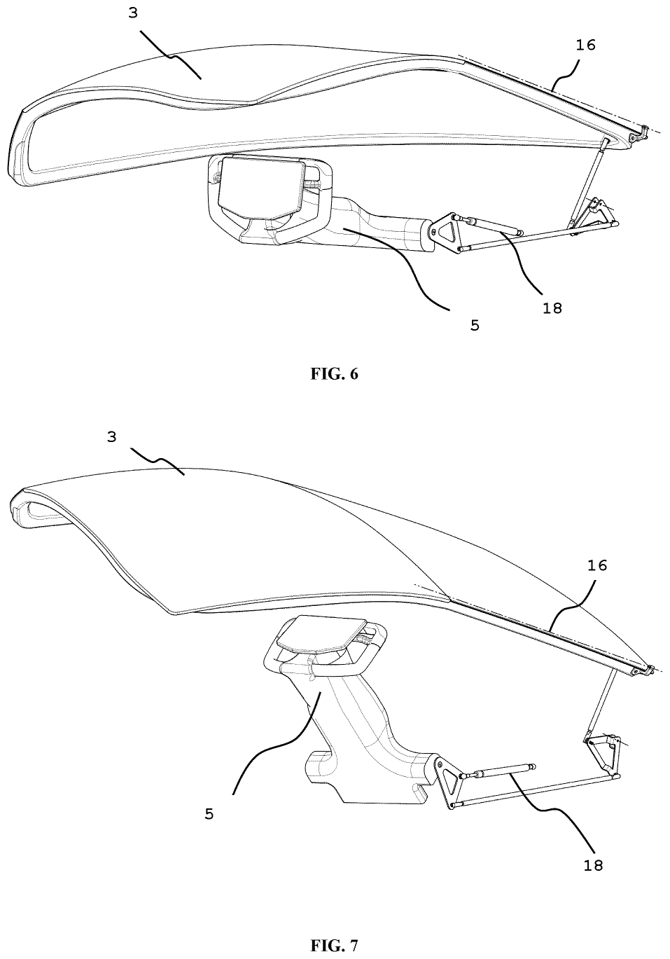

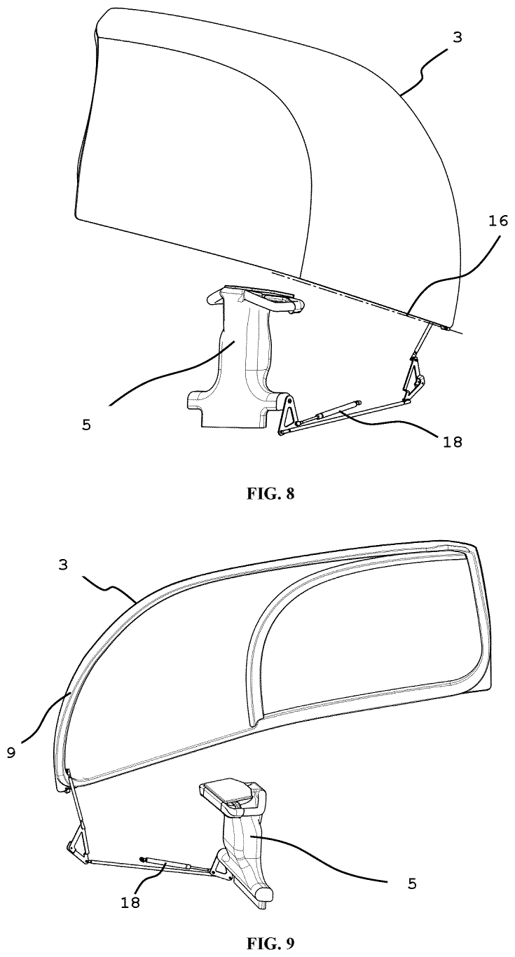

FIG. 6 shows the mechanical linkage when the LH door is in a closed position. FIG. 7 shows the mechanical linkage when the LH door is 45 degrees open, and FIG. 8 shows the mechanical linkage when the LH door is fully open. FIG. 8 particularly illustrates a perspective view of the linkage from the outer side of the fully open LH door, while FIG. 9 illustrates a perspective view of the linkage from the inner side of the fully open LH door.

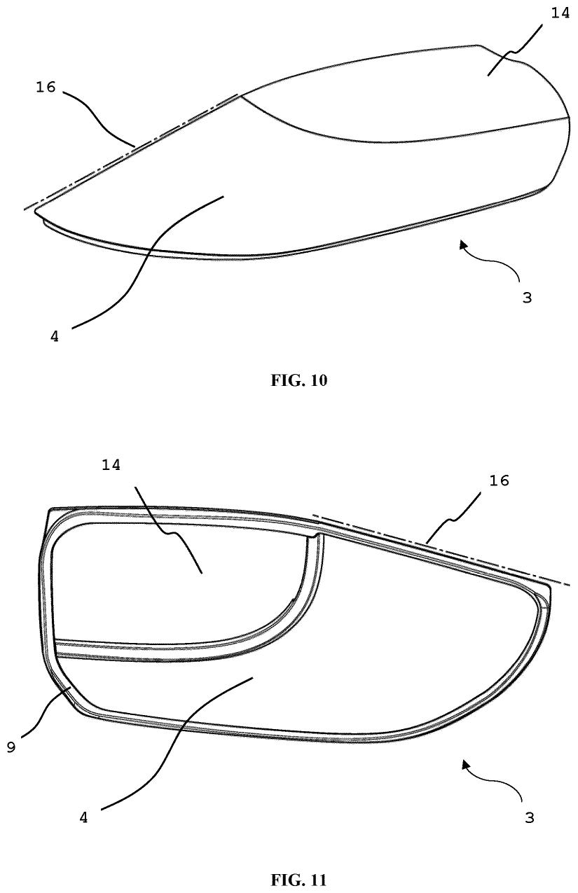

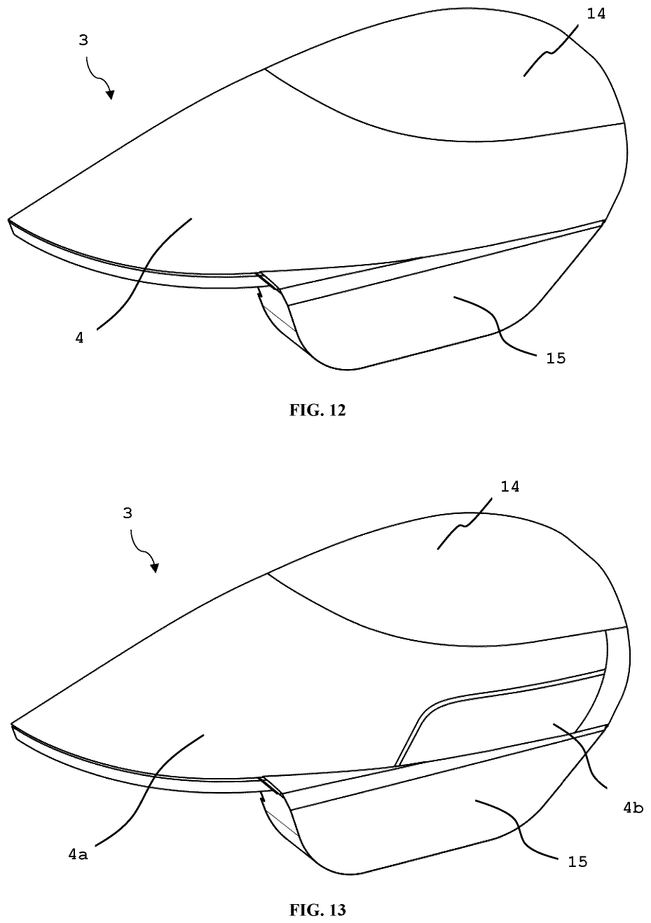

Possible embodiments of door configurations for the single A post vehicle door assembly according to the invention are shown in FIGS. 10-13. According to the invention, the door can incorporate either a single fixed glass that is a straightforward configuration (as shown in FIGS. 10-12), or a combination of a fixed glass and a rolling side window glass (as shown in FIG. 13), which allows for versatility and ventilation.

Particularly, FIGS. 10 and 11 show front and rear views of one possible embodiment of the LH door 3 that contains a single glass LH windshield section 4 and a LH vehicle roof portion 14. The RH door 3′ is symmetrically identical to the LH door 3 and in this embodiment contains a single glass RH windshield section 4′ and a RH vehicle roof portion. Focused on performance and minimalism, this configuration prioritizes simplicity and functionality, maximizes the body stiffness, and minimizes the weight. This embodiment is ideal for a track car where performance is prioritized over the comfort of ingress/egress.

FIG. 12 shows a front view of another possible embodiment of the LH door 3 that contains a single glass LH windshield section 4, the LH vehicle roof portion 14 and a LH vehicle side body portion 15. The RH door 3′ is symmetrically identical to the LH door 3 and in this embodiment contains a single glass RH windshield section 4′, the RH vehicle roof portion and a RH vehicle side body portion. This single glass configuration provides light weight and structural integrity, and a comprehensive panoramic view by featuring a single glass panel that merges the windshield and door. In addition, it offers comfortable ingress/egress.

FIG. 13 shows a front view of one more possible embodiment of the LH door 3 that contains the LH windshield section, the LH vehicle roof portion 14 and a LH vehicle side body portion 15. In this embodiment, the LH windshield section is composed by two glasses, a LH windshield section front glass 4a and a LH windshield section side glass 4b. The RH door 3′ is symmetrically identical to the LH door 3 and in this embodiment contains the RH windshield section, the RH vehicle roof portion and a RH vehicle side body portion, wherein the RH windshield section is composed by two glasses, a RH windshield section front glass and a RH windshield section side glass. The side glass in this embodiment of the doors is retractable. It benefits from comfortable ingress/egress and offers added functionality with retractable side glass for ventilation and versatility, perfectly integrating with the door's innovative opening mechanism.

The single A-post vehicle door assembly according to the present invention can be manufactured as follows.
1. Curved glass and frame bonding. A curved glass is securely bonded to the frame 9 ensuring a cohesive structure where the glass and framework are connected together seamlessly. This process is crucial for the aesthetic and structural integrity of the door, so that a perfect amalgamation of glass into the door frame is achieved.
2. Hinge placement. The two hinges 12, 13 are attached to a vertical section of the door frame 9 and are mounted, one at the upper part of the A post 2 and another one at the lower part of the A post 2. This strategic placement enhances door's stability and smooth operation.
3. Seals. The seals are attached either to the body 6 of the vehicle 1 or directly to the door 3, 3′, or to both the door 3, 3′ and the vehicle body 6 (FIG. 4 shows a secondary door seal 8 provided on the door 3, 3′ and a corresponding primary door seal 7 provided on the vehicle body 6). These seals 7, 8 play a vital role in maintaining a weather-tight closure when the door 3, 3′ is shut and in enhancing the vehicle's acoustic properties.
4. Supporting Mechanism. To facilitate smooth and effortless opening and closing of the doors, the door 3, 3′ is further provided with the supporting mechanism (such as a gas strut, a spring, an electric drive unit, a hydraulic or pneumatic system, or other aided opening/closing devices).

As can be learned from the above detailed description, the operation of the single A post vehicle door assembly leverages a central A post configuration, where two pivotal hinges for each door are supported. This configuration enables the door and integrated windshield section to pivot in unison, thereby optimizing the space for entry and exit and enhancing visibility. In one of the preferred embodiments, the mounted steering column on the door frame moves in sync with the door, offering significant clearance. This seamless operation is further ensured by the integration of the primary and secondary door seals for a secure closure.

The door's operational versatility is supported by both manual and automated mechanisms, accommodating various user preferences and vehicle specifications. The steer-by-wire system, whether integrated with one of the doors of the single A post vehicle door assembly or operating independently, marks a significant advancement in automotive technology by eliminating the mechanical constraints of steering, thus optimizing the interior space.

The steer-by-wire system is a cornerstone of the present invention, showcasing the commitment to innovation. This system allows for a flexible configuration approach, enabling a reimagined vehicle control interaction and heralding a new era of automotive design.

In conclusion, the detailed exploration of the vehicle door assembly with a single A post illustrates the present invention's innovative approach to improving vehicle configuration and functionality. By redefining the structural and operational aspects of automotive doors, the present invention sets a new standard, promising enhanced user experience and vehicle performance.

Although the present invention has been illustrated and described herein with reference to preferred embodiments and specific examples thereof, the above disclosed subject-matter is to be considered not restrictive and serves to provide a better understanding of the present invention. It will be readily apparent to those of ordinary skill in the art that other embodiments and examples may perform similar functions and/or achieve like results. All such equivalent embodiments and examples are within the spirit and scope of the present invention.

What is claimed is:

1. A vehicle door assembly, comprising a door and an A post positioned substantially along a centerline of a vehicle, wherein the door is movably attached to the A post by at least two hinges at corresponding at least two locations along the A post, wherein the door comprises a portion of a windshield of the vehicle, a door frame and a portion of a roof of the vehicle, wherein the door is a right-hand door or a left-hand door.

2. The vehicle door assembly as claimed in claim 1, wherein one of the at least two hinges is located on the A post in an area of a lower part of the windshield, and another one of the at least two hinges is located on the A post in an area of an upper part of the windshield.

3. The vehicle door assembly as claimed in claim 1, wherein the door is supported via a supporting mechanism to facilitate smooth opening and closing, the supporting mechanism selected from a gas strut, an electric drive unit, a hydraulic system, a pneumatic system and a spring.

4. The vehicle door assembly as claimed in claim 1, wherein the door further comprises a portion of a side body of the vehicle.

5. The vehicle door assembly as claimed in claim 1, wherein the portion of the windshield comprised by the door is made as a single glass or composed by two glasses comprising a front glass and a side glass, wherein the side glass is retractable for ventilation.

6. The vehicle door assembly as claimed in claim 1, wherein the door contains a steer-by-wire steering column mounted on a frame of the door to move together with the door as the door opens for creating more clearance for a driver to enter the vehicle.

7. The vehicle door assembly as claimed in claim 6, wherein the steer-by-wire steering column and the door are mechanically linked using a gas strut.

8. A vehicle door assembly, comprising a left-hand door, a right-hand door, a windshield, and an A post positioned substantially along a centerline of a vehicle, wherein each of the left-hand door and the right-hand door is movably attached to the A post by at least two hinges at corresponding at least two locations along the A post, and wherein the windshield consists of a left-hand windshield section and a right-hand windshield section, which are separated from each other and comprised by the left-hand door and the right-hand door respectively, allowing the left-hand windshield section to open with the left-hand door and the right-hand windshield section to open with the right-hand door, wherein each of the left-hand door and the right-hand door further comprises a door frame and a portion of a roof of the vehicle.

9. The vehicle door assembly as claimed in claim 8, wherein one of the at least two hinges is located on the A post in an area of a lower part of the windshield, and another one of the at least two hinges is located on the A post in an area of an upper part of the windshield.

10. The vehicle door assembly as claimed in claim 8, wherein the at least two hinges of the left-hand door form a singular, left-hand door hinge axis located on the A post, and the at least two hinges of the right-hand door form a singular, right-hand door hinge axis located on the A post.

11. The vehicle door assembly as claimed in claim 8, wherein the left-hand door and the right-hand door are symmetrically identical, and wherein the left-hand windshield section and the right-hand windshield section are symmetrically identical.

12. The vehicle door assembly as claimed in claim 8, wherein each of the left-hand door and the right-hand door is supported via a supporting mechanism to facilitate smooth opening and closing, the supporting mechanism selected from a gas strut, an electric drive unit, a hydraulic system, a pneumatic system and a spring.

13. The vehicle door assembly as claimed in claim 8, wherein each of the left-hand door and the right-hand door further comprises a portion of a side body of the vehicle.

14. The vehicle door assembly as claimed in claim 8, wherein each of the left-hand windshield section and the right-hand windshield section is made as a single glass or composed by two glasses comprising a front glass and a side glass, wherein the side glass is retractable for ventilation.

15. The vehicle door assembly as claimed in claim 8, wherein one of the left-hand door and the right-hand door contains a steer-by-wire steering column that is mounted on a frame of the door to move together with the door as the door opens for creating more clearance for a driver to enter the vehicle.

16. The vehicle door assembly as claimed in claim 15, wherein the steer-by-wire steering column and the one of the left-hand door and the right-hand door are mechanically linked using a gas strut.

17. A vehicle comprising a vehicle door assembly that comprises a door and an A post positioned substantially along a centerline of a vehicle, wherein the door is movably attached to the A post by at least two hinges at corresponding at least two locations along the A post, wherein the door comprises a portion of a windshield of the vehicle, a door frame and a portion of a roof of the vehicle, wherein the door is a right-hand door or a left-hand door.

18. The vehicle as claimed in claim 17, further comprising a steer-by-wire steering system, wherein a steer-by-wire steering column of the steer-by-wire steering system is separate from the door and is movable away from a driver seat either by lifting upward and forward or by lifting upward and sideways.

19. The vehicle as claimed in claim 17, further comprising a steer-by-wire steering system, wherein the door contains a steer-by-wire steering column of the steer-by-wire steering system, wherein the steer-by-wire steering column is mounted on a frame of the door to move together with the door as the door opens for creating more clearance for a driver to enter the vehicle.

20. The vehicle as claimed in claim 17, wherein the vehicle is a motor vehicle selected from sports cars and high-performance cars.
